(19) United States
(12) Patent Application Publication
(10) Pub. No.: US 2015/0104639 A1
(43) Pub. Date: Apr. 16, 2015

(54) Hot Melt Pressure-Sensitive Adhesives for No-Label Look Applications

(71) Applicant: ExxonMobil Chemical Patents Inc., Baytown, TX (US)

(72) Inventors: Jurgen Schroeyers, Helchteren (BE); Christopher L. Curry, Furlong, PA (US); James N. Coffey, League City, TX (US); Jennifer J. Austin, The Woodlands, TX (US); Shawn W. Mowry, Houston, TX (US)

(21) Appl. No.: 14/575,829

(22) Filed: Dec. 18, 2014

Related U.S. Application Data
(63) Continuation-in-part of application No. 13/723,963, filed on Dec. 21, 2012.
Application No. 13/723,963 is a continuation-in-part of application No. 12/880,762, filed on Sep. 13, 2010.
(60) Provisional application No. 61/256,124, filed on Oct. 29, 2009.

(51) Int. Cl. C09J 123/14

(52) U.S. Cl. CPC C09J 123/14; C09J 2201/61; C09J 2201/606
USPC 428/349; 524/505

(57) ABSTRACT

A composition comprising a hot melt pressure-sensitive adhesive comprising a propylene-based polymer component, wherein the propylene-based polymer component has a MFR of greater than about 1,000 g/10 min to less than about 10,000 g/10 min, and free of or having a low block copolymer content. Also, an adhesive article comprising the composition.

### CROSS REFERENCE TO RELATED APPLICATIONS

This application is a continuation-in-part of pending U.S. patent application Ser. No. 13/723,963, filed Dec. 21, 2012, the disclosure of which is fully incorporated herein by reference. U.S. patent application Ser. No. 13/723,963 is a continuation-in-part of U.S. patent application Ser. No. 12/880,762, filed Sep. 13, 2010, which claims priority to U.S. Provisional Application Ser. No. 61/256,124, filed Oct. 29, 2009, the disclosure of which is fully incorporated herein by reference.

### FIELD OF THE INVENTION

The instant disclosure is related to hot melt pressure-sensitive adhesive compositions and their applications. In particular, the adhesive compositions described herein comprise a propylene-based polymer component.

### BACKGROUND

Pressure-sensitive adhesives are well known, and are used in a wide variety of applications, the largest among them being label and tape. Such adhesives may be applied to, for example, paper, plastic films, metal, etc., to form the aforementioned labels or tapes. These labels and tapes may be affixed to a wide variety of substrates, and may be removable or repositionable.

“No-label look” labels, also referred to as “super-transparent” labels, are obtaining popularity and are of significant commercial interest. Adhesives for no-label look labels require a high level of transparency or clarity, along with other properties typical of such adhesives.

Hot melt pressure-sensitive adhesive systems are known in the art and consist of tackified thermoplastic elastomers such as styrenic block copolymers together with tackifying resin(s) and generally some plasticizing oil, an antioxidant, and optional fillers. Styrenic block copolymers containing polystyrene and polybutadiene blocks and/or polyisoprene blocks are particularly useful. These materials are generally available as pure triblocks, sometimes referred to as SIS and SBS copolymers, and diblocks, sometimes referred to as SI and SB copolymers or SIB copolymers. The materials are also available as mixtures of diblock and triblock materials, sometimes referred to as SIS+SI or SIS+SB. Styrenic block copolymers could also have a radial structure generally identified as (SI)n or (SB)n where n for most commercial available polymers equals but is not limited to 4. In (for label) a preferred case, those radial block copolymers are blended with other styrenic block copolymers like diblock and triblock structures.

Adhesive properties and viscosity can be controlled by varying the diblock-to-triblock ratio, varying the styrene content, varying the polymer molecular weight, and/or varying the block molecular weights within the polymers. The melt viscosity can also be controlled by the addition of tackifier resins and/or plasticizers like oils.

One drawback of such adhesive formulations is that, in order to achieve the desired processability of a product, many additives such as silicone oils, waxes, and other fillers must be added. Incorporation of such additives leads to increased expense and also limits the equipment that may be used to manufacture the adhesive compositions.

U.S. Publication No. 2013/0130027 discloses an adhesive composition comprising a propylene-based polymer component with a certain melting point and triad tacticity that is free of or having a low block copolymer content. However, the low melt flow rate/high viscosity of such propylene-based polymer components limits the amount of polymer loaded in the adhesive composition and therefore requires the inclusion of costly additives.

In addition, hot melt pressure-sensitive adhesive systems suitable for use in a no-label look label must have clarity in combination with other properties. It would be useful, therefore, to develop an adhesive composition for use with labels and/or tapes having the properties of a typical block copolymer-based adhesive at a lower cost and with increased processability, and which may be suitable for use in no-label look labels.

### SUMMARY

The instant disclosure is directed to adhesive compositions which function as hot melt pressure-sensitive adhesive compositions and their commercial applications. In one or more embodiments, the hot melt pressure-sensitive adhesive composition comprises a propylene-based polymer component, wherein the propylene-based polymer component comprises a first propylene-based polymer wherein the first propylene-based polymer is a homopolymer of propylene or a copolymer of propylene and ethylene or a C₄ to C₁₀ alpha-olefin and a second propylene-based polymer wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min; and wherein the hot melt pressure-sensitive adhesive composition is free of or comprises not more than about 30 wt % of a block copolymer based on the weight of the hot melt pressure sensitive adhesive composition.

In one or more embodiments, the adhesive article comprises a substrate and a hot melt pressure-sensitive adhesive composition comprising a propylene-based polymer component, wherein the propylene-based polymer component comprises a first propylene-based polymer wherein the first propylene-based polymer is a homopolymer of propylene or a copolymer of propylene and ethylene or a C₄ to C₁₀ alpha-olefin and a second propylene-based polymer wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min; and wherein the adhesive composition free of or comprising less than about 30 wt % of a block copolymer based on the weight of the hot melt pressure-sensitive adhesive.

The compositions described herein in some embodiments combine excellent viscosity and/or shear properties while improving the performance of tapes, labels, and other applications in which the adhesives are employed, and may have clarity suitable for use in no-label look labels. In further embodiments, adhesive articles such as adhesive tapes and labels comprise a substrate and one or more hot melt pressure-sensitive adhesive compositions according to one or more embodiments described herein. Embodiments of the resulting adhesive tapes may demonstrate good removability and/or repositionability, along with exceptional peel strength on one or more of various surfaces.

### DETAILED DESCRIPTION

For purposes herein, a pressure sensitive adhesive (PSA) forms a bond by the application of light pressure to many the adhesive with the adherend. The bond forms because the adhesive is soft enough to flow (i.e.“wet”) to the adherend. The bond has strength because the adhesive is hard enough to resist flow when stress is applied to the bond. Once the adhesive and the adherend are in close proximity, molecular interactions, such as Van der Waals forces, become involved in the bond, contributing significantly to its ultimate strength.

The compositions according to the instant disclosure possess a glass transition temperature (Tg), at which the molecular chain exhibits the greatest free volume or maximum flow character. When a material is heated from its glassy state to either a rubbery or a fluid state, if Tg appears in the vicinity of room temperature and the value of Tangent delta (damping factor, the ratio of loss modulus-G″ to storage modulus-G′) is greater than one (1), the material cold flows and is considered to be pressure sensitive.

PSAs, according to embodiments disclosed herein, may be either permanent or removable applications. For purposes herein removable adhesives, including PSA and articles comprising PSAs are compositions which form a temporary bond, and ideally can be removed after months or years without leaving residue on the adherend. Removable adhesives are used in applications such as surface protection films, masking tapes, bookmark and note papers, price marking labels, promotional graphics materials, and the like, whereas a permanent PSA refers to a PSA film which may be initially removable (for example to recover mislabeled goods) and, which builds adhesion to a permanent bond after several hours or days.

Examples of permanent applications include safety labels for power equipment, foil tape for HVAC duct work, automotive interior trim assembly, and sound/vibration damping films. Embodiments include so-called high performance permanent PSAs which exhibit high adhesion values and can support kilograms of weight per square centimeter of contact area, even at elevated temperature. Permanent PSAs may be initially removable (for example to recover mislabeled goods) and build adhesion to a permanent bond after several hours or days.

For purposes herein removable adhesives and articles comprising the same refer to compositions which form a temporary bond, and ideally can be removed after months or years without leaving residue on the adherend. Removable adhesives are used in applications such as surface protection films, masking tapes, bookmark and note papers, price marking labels, promotional graphics materials. Some removable adhesives are designed to repeatedly stick and unstick.

In addition to being pressure sensitive adhesives, the instant disclosure is directed to PSA which are also hot melt adhesives, which are generally defined as thermoplastic compositions applied in molten form, which solidify on cooling to form strong bonds between a wide range of materials. Accordingly, in an embodiment, the compositions disclosed herein include hot melt pressure-sensitive adhesives (HMPSA).

### Propylene-Based Polymer Component

The Propylene-based polymer components (“PBPs”) useful for making the fibers and fabrics of the invention comprise a first predominantly propylene-based polymer, wherein the first predominantly propylene-based polymer is a homopolymer of propylene or a copolymer of propylene and ethylene or a C₄ to C₁₀ alpha-olefin; and a second predominantly propylene-based polymer, wherein the second predominantly propylene-based polymer is a homopolymer of propylene or comprises a comonomer of ethylene or a C₄ to C₁₀ alpha-olefin; wherein the second predominantly propylene-based polymer is compositionally different than the first predominantly propylene-based polymer.

### Methods of Preparing PBPs

A solution polymerization process for preparing a PBP is generally performed by a system that includes a first reactor, a second reactor in parallel with the first reactor, a liquid-phase separator, a devolatilizing vessel, and a pelletizer. The first reactor and second reactor may be, for example, continuously stirred-tank reactors.

The first reactor may receive a first monomer feed, a second monomer feed, and a catalyst feed. The first reactor may also receive feeds of a solvent and an activator. The solvent and/or the activator feed may be combined with any of the first monomer feed, the second monomer feed, or catalyst feed or the solvent and activator may be supplied to the reactor in separate feed streams. A first polymer is produced in the first reactor and is evacuated from the first reactor via a first product stream. The first product stream comprises the first polymer, solvent, and any unreacted monomer.

In any embodiment, the first monomer in the first monomer feed may be propylene and the second monomer in the second monomer feed may be ethylene or a C₄ to C₁₀ olefin. In any embodiment, the second monomer may be ethylene, butene, hexene, and octene. Generally, the choice of monomers and relative amounts of chosen monomers employed in the process depends on the desired properties of the first polymer and final PBP. For fiber compositions, ethylene and hexene are particularly preferred comonomers for copolymerization with propylene. In any embodiment, the relative amounts of propylene and comonomer supplied to the first reactor may be designed to produce a polymer that is predominantly propylene, i.e., a polymer that is more than 50 mol % propylene. In another embodiment, the first reactor may produce a homopolymer of propylene.

Preferably, the second polymer is different than the first polymer. The difference may be measured, for example, by the comonomer content, heat of fusion, crystallinity, branching index, weight average molecular weight, and/or polydispersity of the two polymers. In any embodiment, the second polymer may comprise a different comonomer than the first polymer or one polymer may be a homopolymer of propylene and the other polymer may comprise a copolymer of propylene and ethylene or a C₄ to C₁₀ olefin. For example, the first polymer may comprise a propylene-ethylene copolymer and the second polymer may comprise a propylene-hexene copolymer. In any embodiment, the second polymer may have a different weight average molecular weight (Mw) than the first polymer and/or a different melt viscosity than the first polymer. Furthermore, in any embodiment, the second polymer may have a different crystallinity and/or heat of fusion than the first polymer.

It should be appreciated that any number of additional reactors may be employed to produce other polymers that may be integrated with (e.g., grafted) or blended with the first and second polymers. Further description of exemplary methods for polymerizing the polymers described herein may be found in U.S. Pat. No. 6,881,800, which is incorporated by reference herein.

The first product stream and second product stream may be combined to produce a blend stream. For example, the first product stream and second product stream may supply the first and second polymer to a mixing vessel, such as a mixing tank with an agitator.

The blend stream may be fed to a liquid-phase separation vessel to produce a polymer rich phase and a polymer lean phase. The polymer lean phase may comprise the solvent and be substantially free of polymer. At least a portion of the polymer lean phase may be evacuated from the liquid-phase separation vessel via a solvent recirculation stream. The solvent recirculation stream may further include unreacted monomer. At least a portion of the polymer rich phase may be evacuated from the liquid-phase separation vessel via a polymer rich stream.

In any embodiment, the liquid-phase separation vessel may operate on the principle of Lower Critical Solution Temperature (LCST) phase separation. This technique uses the thermodynamic principle of spinodal decomposition to generate two liquid phases; one substantially free of polymer and the other containing the dissolved polymer at a higher concentration than the single liquid feed to the liquid-phase separation vessel.

Employing a liquid-phase separation vessel that utilizes spinodal decomposition to achieve the formation of two liquid phases may be an effective method for separating solvent from multi-modal polymer PBPs, particularly in cases in which one of the polymers of the PBP has a weight average molecular weight less than 100,000 g/mol, and even more particularly between 10,000 g/mol and 60,000 g/mol. The concentration of polymer in the polymer lean phase may be further reduced by catalyst selection. Catalysts of Formula I (described below), particularly dimethylsilyl bis(2-methyl-4-phenylindenyl)zirconium dichloride, dimethylsilyl bis(2-methyl-5-phenylindenyl)hafnium dichloride, dimethylsilyl bis(2-methyl-4-phenylindenyl)zirconium dimethyl, and dimethylsilyl bis(2-methyl-4-phenylindenyl)hafnium dimethyl were found to be a particularly effective catalysts for minimizing the concentration of polymer in the lean phase. Accordingly, in any embodiment, one, both, or all polymers may be produced using a catalyst of Formula I, particularly dimethylsilyl bis(2-methyl-4-phenylindenyl)zirconium dichloride, dimethylsilyl bis(2-methyl-4-phenylindenyl)hafnium dichloride, dimethylsilyl bis(2-methyl-4-phenylindenyl)zirconium dimethyl, and dimethylsilyl bis(2-methyl-4-phenylindenyl)hafnium dimethyl.

Upon exiting the liquid-phase separation vessel, the polymer rich stream may then be fed to a devolatilizing vessel for further polymer recovery. In any embodiment, the polymer rich stream may also be fed to a low pressure separator before being fed to the inlet of the devolatilizing vessel. While in the vessel, the polymer composition may be subjected to a vacuum in the vessel such that at least a portion of the solvent is removed from the polymer composition and the temperature of the polymer composition is reduced, thereby forming a second polymer composition comprising the PBP and having a lower solvent content and a lower temperature than the polymer composition as the polymer composition is introduced into the vessel. The polymer composition may then be discharged from the outlet of the vessel via a discharge stream.

The cooled discharge stream may then be fed to a pelletizer where the PBP is then discharged through a pelletization die as formed pellets. Pelletization of the polymer may be by an underwater, hot face, strand, water ring, or other similar pelletizer. Preferably an underwater pelletizer is used, but other equivalent pelletizing units known to those skilled in the art may also be used. General techniques for underwater pelletizing are known to those of ordinary skill in the art.

International Publication No. 2013/134038 generally describes the method of preparing PBPs. The contents of International Publication No. 2013/134038 and its parent application U.S. Patent Application Ser. No. 61/609,020 filed Mar. 9, 2012, are both incorporated herein in their entirety.

### Polymers of the PBPs

Preferred polymers of the PBP are semi-crystalline propylene-based polymers. In any embodiment, the polymers may have a relatively low molecular weight, preferably about 150,000 g/mol or less. In any embodiment, the polymer may comprise a comonomer selected from the group consisting of ethylene and linear or branched C₄ to C₂₀ olefins and diolefins. In any embodiment, the comonomer may be ethylene or a C₄ to C₁₀ olefin.

In any embodiment, one or more polymers of the PBP may comprise one or more propylene-based polymers, which comprise propylene and from about 5 mol % to about 30 mol % of one or more comonomers selected from C₂ and C₄-C₁₀ α-olefins. In any embodiment, the α-olefin comonomer units may derive from ethylene, butene, pentene, hexene, 4-methyl-1-pentene, octene, or decene. The embodiments described below are discussed with reference to ethylene and hexene as the α-olefin comonomer, but the embodiments are equally applicable to other copolymers with other α-olefin comonomers. In this regard, the copolymers may simply be referred to as propylene-based polymers with reference to ethylene or hexene as the α-olefin.

In any embodiment, the one or more polymers of the PBP may include at least about 5 mol %, at least about 6 mol %, at least about 7 mol %, or at least about 8 mol %, or at least about 10 mol %, or at least about 12 mol % ethylene-derived or hexene-derived units. In those or other embodiments, the copolymers may include up to about 30 mol %, or up to about 25 mol %, or up to about 22 mol %, or up to about 20 mol %, or up to about 19 mol %, or up to about 18 mol %, or up to about 17 mol % ethylene-derived or hexene-derived units, where the percentage by mole is based upon the total moles of the propylene-derived and α-olefin derived units. Stated another way, the propylene-based polymer may include at least about 70 mol %, or at least about 75 mol %, or at least about 80 mol %, or at least about 81 mol % propylene-derived units, or at least about 82 mol % propylene-derived units, or at least about 83 mol % propylene-derived units; and in these or other embodiments, the copolymers may include up to about 95 mol %, or up to about 94 mol %, or up to about 93 mol %, or up to about 92 mol %, or up to about 90 mol %, or up to about 88 mol % propylene-derived units, where the percentage by mole is based upon the total moles of the propylene-derived and alpha-olefin derived units. In any embodiment, the propylene-based polymer may comprise from about 5 mol % to about 25 mol % ethylene-derived or hexene-derived units, or from about 8 mol % to about 20 mol % ethylene-derived or hexene-derived units, or from about 12 mol % to about 18 mol % ethylene-derived or hexene-derived units.

The one or more polymers of the PBP of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In any embodiment, the Tm of the one or more polymers of the PBP (as determined by DSC) may be less than about 130° C., or less than about 120° C., or less than about 115° C., or less than about 110° C., or less than about 100° C., or less than about 90° C. In any embodiment, the Tm of the one or more polymers of the PBP may be greater than about 25° C., or greater than about 30° C., or greater than about 35° C., or greater than about 40° C. Tm of the one or more polymers of the PBP can be determined by taking 5 to 10 mg of a sample of the one or more polymers, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., ramping the temperature at a rate of 10° C. per minute up to 200° C., maintaining the temperature for 5 minutes, and recording the temperature as Tm.

In one or more embodiments, the crystallization temperature (Tc) of the one or more polymers of the PBP (as determined by DSC) is less than about 100° C., or less than about 90° C., or less than about 80° C., or less than about 70° C., or less than about 60° C., or less than about 50° C., or less than about 40° C., or less than about 30° C., or less than about 20° C., or less than about 10° C. In the same or other embodiments, the Tc of the polymer is greater than about 0° C., or greater than about 5° C., or greater than about 10° C., or greater than about 15° C., or greater than about 20° C. In any embodiment, the Tc lower limit of the polymer may be 0° C., 5° C., 10° C., 20° C., 30° C., 40° C., 50° C., 60° C., and 70° C.; and the Tc upper limit temperature may be 120° C., 110° C., 100° C., 90° C., 80° C., 70° C., 60° C., 50° C., 40° C., 30° C., 25° C., and 20° C. with ranges from any lower limit to any upper limit being contemplated. Tc of the polymer blend can be determined by taking 5 to 10 mg of a sample of the polymer blend, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., and recording the temperature as Tc.

The polymers suitable for in the PBP are said to be “semi-crystalline,” meaning that in general they have a relatively low crystallinity. The term “crystalline” as used herein broadly characterizes those polymers that possess a high degree of both inter and intra molecular order, and which preferably melt higher than 110° C., more preferably higher than 115° C., and most preferably above 130° C. A polymer possessing a high inter and intra molecular order is said to have a “high” level of crystallinity, while a polymer possessing a low inter and intra molecular order is said to have a “low” level of crystallinity. Crystallinity of a polymer can be expressed quantitatively, e.g., in terms of percent crystallinity, usually with respect to some reference or benchmark crystallinity. As used herein, crystallinity is measured with respect to isotactic polypropylene homopolymer. Preferably, heat of fusion is used to determine crystallinity. Thus, for example, assuming the heat of fusion for a highly crystalline polypropylene homopolymer is 190 J/g, a semi-crystalline propylene copolymer having a heat of fusion of 95 J/g will have a crystallinity of 50%. The term “crystallizable” as used herein refers to those polymers which can crystallize upon stretching or annealing. Thus, in certain specific embodiments, the semi-crystalline polymer may be crystallizable. The semi-crystalline polymers used in specific embodiments of this invention preferably have a crystallinity of from 2% to 65% of the crystallinity of isotatic polypropylene. In further embodiments, the semi-crystalline polymers may have a crystallinity of from about 3% to about 40%, or from about 4% to about 30%, or from about 5% to about 25% of the crystallinity of isotactic polypropylene.

The semi-crystalline polymer of the PBP can have a level of isotacticity expressed as percentage of isotactic triads (three consecutive propylene units), as measured by 13C NMR, of 75 mol % or greater, 80 mol % or greater, 85 mol % or greater, 90 mol % or greater, 92 mol % or greater, 95 mol % or greater, or 97 mol % or greater. In one or more embodiments, the triad tacticity may range from about 75 mol % to about 99 mol %, or from about 80 mol % to about 99 mol %, or from about 85 mol % to about 99 mol %, or from about 90 mol % to about 99 mol %, or from about 90 mol % to about 97 mol %, or from about 80 mol % to about 97 mol %. Triad tacticity is determined by the methods described in U.S. Patent Application Publication No. 2004/0236042.

The semi-crystalline polymer of the PBP may have a tacticity index m/r ranging from a lower limit of 4, or 6 to an upper limit of 10, or 20, or 25. The tacticity index, expressed herein as “m/r”, is determined by 13C nuclear magnetic resonance (“NMR”). The tacticity index m/r is calculated as defined by H. N. Cheng in Macromolecules, 17, 1950 (1984), incorporated herein by reference. The designation “m” or “r” describes the stereochemistry of pairs of contiguous propylene groups, “m” referring to meso and “r” to racemic. An m/r ratio of 1.0 generally describes an atactic polymer, and as the m/r ratio approaches zero, the polymer is increasingly more syndiotactic. The polymer is increasingly isotactic as the m/r ratio increases above 1.0 and approaches infinity.

In one or more embodiments, the semi-crystalline polymer of the PBP may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature and determined according to ASTM D-792.

In one or more embodiments, the semi-crystalline polymer of the PBP can have a weight average molecular weight (Mw) of from about 5,000 to about 500,000 g/mol, or from about 7,500 to about 300,000 g/mol, or from about 10,000 to about 200,000 g/mol, or from about 25,000 to about 175,000 g/mol.

Weight-average molecular weight, Mw, molecular weight distribution (MWD) or Mw/Mn (also referred to as polydispersity index) where Mn is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in: T. Sun, P. Brant, R. R. Chance, and W. W. Graessley, Macromolecules, Volume 34, Number 19, pp. 6812-6820, 2001. In one or more embodiments, the PBP can have a polydispersity index of from about 1.5 to about 6.

In an embodiment, the PBP has a melt viscosity, measured at 190° C. within the range of from about 800 or 1,000 or 5,000 cP to about 10,000 or 15,000 cP. In an embodiment, the PBP has a Melt Flow Rate (“MFR”, 230° C./2.16 kg) within the range of from about 1,000 or 2,000 g/10 min to about 5,000 or 10,000 g/10 min.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples.

The concentration, c, at each point in the chromatogram is calculated from the baseline-subtracted DRI signal, IDRI, using the following equation:

c=KDRIIDRI/(dn/dc)

where KDRI is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[Koc/ΔR(θ,c)]=[1/MP(θ)]+2A2c

where ΔR(θ) is the measured excess Rayleigh scattering intensity at scattering angle θ, c is the polymer concentration determined from the DRI analysis, A2 is the second virial coefficient, P(θ) is the form factor for a monodisperse random coil (described in the above reference), and Ko is the optical constant for the system:

$${K}_{o} = \frac{4 {π}^{2} {{n}^{2} ( dn / dc )}^{2}}{{λ}^{4} {N}_{A}}$$

in which NA is the Avogadro's number, and dn/dc is the refractive index increment for the system. The refractive index, n=1.500 for TCB at 135° C. and λ=690 nm. In addition, A2=0.0015 and dn/dc=0.104 for ethylene polymers, whereas A2=0.0006 and dn/dc=0.104 for propylene polymers.

The molecular weight averages are usually defined by considering the discontinuous nature of the distribution in which the macromolecules exist in discrete fractions i containing Ni molecules of molecular weight Mi. The weight-average molecular weight, Mw, is defined as the sum of the products of the molecular weight Mi of each fraction multiplied by its weight fraction wi:

Mw≡ΣwiMi=(ΣNiMi2/ΣNiMi)

since the weight fraction wi is defined as the weight of molecules of molecular weight Mi divided by the total weight of all the molecules present:

wi=NiMi/ΣNiMi

The number-average molecular weight, Mn, is defined as the sum of the products of the molecular weight Mi of each fraction multiplied by its mole fraction xi:

Mn≡ΣxiMi=ΣNiMi/ΣNi

since the mole fraction xi is defined as Ni divided by the total number of molecules

xi=Ni/ΣNi

In the SEC, a high temperature Viscotek Corporation viscometer is used, which has four capillaries arranged in a Wheatstone Bridge configuration with two pressure transducers. One transducer measures the total pressure drop across the detector, and the other, positioned between the two sides of the bridge, measures a differential pressure. The specific viscosity, ηs, for the solution flowing through the viscometer is calculated from their outputs. The intrinsic viscosity, [η], at each point in the chromatogram is calculated from the following equation:

ηs=c[η]+0.3(c[η])2

where c was determined from the DRI output.

The branching index (g′, also referred to as g′(vis)) is calculated using the output of the SEC-DRI-LS-VIS method as follows. The average intrinsic viscosity, [η]avg, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ is defined as:

$${g}^{′} = \frac{{[ η ]}_{avg}}{{kM}_{v}^{α}}$$

where k=0.000579 and α=0.695 for ethylene polymers; k=0.0002288 and α=0.705 for propylene polymers; and k=0.00018 and α=0.7 for butene polymers.

Mv is the viscosity-average molecular weight based on molecular weights determined by the LS analysis:

Mv≡(ΣciMiα/'ci)1/α

In one or more embodiments, the semi-crystalline polymer of the PBP may have a viscosity (also referred to a Brookfield viscosity or melt viscosity), measured at 190° C. and determined according to ASTM D-3236 from about 100 cP to about 500,000 cP, or from about 100 to about 100,000 cP, or from about 100 to about 50,000 cP, or from about 100 to about 25,000 cP, or from about 100 to about 15,000 cP, or from about 100 to about 10,000 cP, or from about 100 to about 5,000 cP, or from about 500 to about 15,000 cP, or from about 500 to about 10,000 cP, or from about 500 to about 5,000 cP, or from about 1,000 to about 10,000 cP, wherein 1 cP=1 mPa·sec.

The polymers that may be used in the fiber compositions disclosed herein generally include any of the polymers formed as disclosed in International Publication No. 2013/134038. The triad tacticity and tacticity index of a polymer may be controlled by the catalyst, which influences the stereoregularity of propylene placement, the polymerization temperature, according to which stereoregularity can be reduced by increasing the temperature, and by the type and amount of a comonomer, which tends to reduce the length of crystalline propylene derived sequences.

Polymers and blended polymer products are also provided. In any embodiment, one or more of the polymers described herein may be blended with another polymer, such as another polymer described herein, to produce a physical blend of polymers.

### Catalysts/Activators for Preparing PBPs

In any embodiment, the catalyst systems used for producing semi-crystalline polymers of the PBP may comprise a metallocene compound. In any embodiment, the metallocene compound may be a bridged bisindenyl metallocene having the general formula (In1)Y(In2)MX2, where In1 and In2 are identical substituted or unsubstituted indenyl groups bound to M and bridged by Y, Y is a bridging group in which the number of atoms in the direct chain connecting In1 with In2 is from 1 to 8 and the direct chain comprises C, Si, or Ge; M is a Group 3, 4, 5, or 6 transition metal; and X2 are leaving groups. In1 and In2 may be substituted or unsubstituted. If In1 and In2 are substituted by one or more substituents, the substituents are selected from the group consisting of a halogen atom, C₁ to C₁₀ alkyl, C₅ to C₁₅ aryl, C₆ to C₂₅ alkylaryl, and Si-, N- or P-containing alkyl or aryl. Each leaving group X may be an alkyl, preferably methyl, or a halide ion, preferably chloride or fluoride. Exemplary metallocene compounds of this type include, but are not limited to, μ-dimethylsilylbis(indenyl) hafnium dimethyl and μ-dimethylsilylbis(indenyl) zirconium dimethyl.

In any embodiment, the metallocene compound may be a bridged bisindenyl metallocene having the general formula (In1)Y(In2)MX2, where In1 and In2 are identical 2,4-substituted indenyl groups bound to M and bridged by Y, Y is a bridging group in which the number of atoms in the direct chain connecting In1 with In2 is from 1 to 8 and the direct chain comprises C, Si, or Ge, M is a Group 3, 4, 5, or 6 transition metal, and X2 are leaving groups. In1 and In2 are substituted in the 2 position by a C₁ to C₁₀ alkyl, preferably a methyl group and in the 4 position by a substituent selected from the group consisting of C₅ to C₁₅ aryl, C₆ to C₂₅ alkylaryl, and Si-, N- or P-containing alkyl or aryl. Each leaving group X may be an alkyl, preferably methyl, or a halide ion, preferably chloride or fluoride. Exemplary metallocene compounds of this type include, but are not limited to, (dimethylsilyl)bis(2-methyl-4-(3,′5′-di-tert-butylphenyl)indenyl) zirconium dimethyl, (dimethylsilyl)bis(2-methyl-4-(3,′5′-di-tert-butylphenyl)indenyl) hafnium dimethyl, (dimethylsilyl)bis(2-methyl-4-naphthylindenyl) zirconium dimethyl, (dimethylsilyl)bis(2-methyl-4-naphthylindenyl) hafnium dimethyl, (dimethylsilyl)bis(2-methyl-4-(N-carbazyl)indenyl) zirconium dimethyl, and (dimethylsilyl)bis(2-methyl-4-(N-carbazyl)indenyl) hafnium dimethyl.

Alternatively, in any embodiment, the metallocene compound may correspond to one or more of the formulas disclosed in U.S. Pat. No. 7,601,666. Such metallocene compounds include, but are not limited to, dimethylsilyl bis(2-(methyl)-5,5,8,8-tetramethyl-5,6,7,8-tetrahydrobenz(f)indenyl) hafnium dimethyl, diphenylsilyl bis(2-(methyl)-5,5,8,8-tetramethyl-5,6,7,8-tetrahydrobenz(f)indenyl) hafnium dimethyl, diphenylsilyl bis(5,5,8,8-tetramethyl-5,6,7,8-tetrahydrobenz(f)indenyl) hafnium dimethyl, diphenylsilyl bis(2-(methyl)-5,5,8,8-tetramethyl-5,6,7,8-tetrahydrobenz(f) indenyl) zirconium dichloride, and cyclo-propylsilyl bis(2-(methyl)-5,5,8,8-tetramethyl-5,6,7,8-tetrahydrobenz(f)indenyl) hafnium dimethyl.

In any embodiment, the activators of the catalyst systems used to produce semi-crystalline polymers of the PBP may comprise a cationic component. In any embodiment, the cationic component may have the formula [R₁R₂R₃AH]+, where A is nitrogen, R₁ and R₂ are together a —(CH₂)a- group, where a is 3, 4, 5, or 6 and form, together with the nitrogen atom, a 4-, 5-, 6-, or 7-membered non-aromatic ring to which, via adjacent ring carbon atoms, optionally one or more aromatic or heteroaromatic rings may be fused, and R₃ is C₁, C₂, C₃, C₄, or C₅ alkyl, or N-methylpyrrolidinium or N-methylpiperidinium. Alternatively, in any embodiment, the cationic component has the formula [RnAH4-n]+, where A is nitrogen, n is 2 or 3, and all R are identical and are C₁ to C₃ alkyl groups, such as for example trimethylammonium, trimethylanilinium, triethylammonium, dimethylanilinium, or dimethylammonium.

A particularly advantageous catalyst that may be employed in any embodiment is illustrated in Formula I.

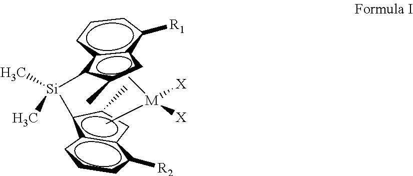

In any embodiment, M is a Group IV transition metal atom, preferably a Group IVB transition metal, more preferably hafnium or zirconium, and X are each an alkyl, preferably methyl, or a halide ion, preferably chloride or fluoride. Methyl or chloride leaving groups are most preferred. In any embodiment, R₁ and R₂ may be independently selected from the group consisting of hydrogen, phenyl, and naphthyl. R₁ is preferably the same as R₂. Particularly advantageous species of Formula I are dimethylsilyl bis(2-methyl-4-phenylindenyl)zirconium dichloride, dimethylsilyl bis(2-methyl-4-phenylindenyl)zirconium dimethyl, dimethylsilyl bis(2-methyl-4-phenylindenyl)hafnium dichloride, and dimethylsilyl bis(2-methyl-4-phenylindenyl)hafnium dimethyl.

Any catalyst system resulting from any combination of a metallocene compound, a cationic activator component, and an anionic activator component mentioned in this disclosure shall be considered to be explicitly disclosed herein and may be used in accordance with the present invention in the polymerization of one or more olefin monomers. Also, combinations of two different activators can be used with the same or different metallocene(s).

In any embodiment, the activators of the catalyst systems used to produce the semi-crystalline polymers may comprise an anionic component, [Y]−. In any embodiment, the anionic component may be a non-coordinating anion (NCA), having the formula [B(R₄)4]−, where R₄ is an aryl group or a substituted aryl group, of which the one or more substituents are identical or different and are selected from the group consisting of alkyl, aryl, a halogen atom, halogenated aryl, and haloalkylaryl groups. The substituents may be perhalogenated aryl groups, or perfluorinated aryl groups, including, but not limited to, perfluorophenyl, perfluoronaphthyl and perfluorobiphenyl.

Together, the cationic and anionic components of the catalysts systems described herein form an activator compound. In any embodiment, the activator may be N,N-dimethylanilinium-tetra(perfluorophenyl)borate, N,N-dimethylanilinium-tetra(perfluoronaphthyl)borate, N,N-dimethylanilinium-tetrakis(perfluorobiphenyl)borate, N,N-dimethylanilinium-tetrakis(3,5-bis(trifluoromethyl)phenyl)borate, triphenylcarbenium-tetra(perfluorophenyl)borate, triphenylcarbenium-tetra(perfluoronaphthyl)borate, triphenylcarbenium-tetrakis(perfluorobiphenyl)borate, or triphenylcarbenium-tetrakis(3,5-bis(trifluoromethyl)phenyl)borate.

A non-coordinating anion activator may be employed with the catalyst. A particularly advantageous activator is dimethylaniliniumtetrakis(heptafluoronaphthyl) borate.

Suitable activators for the processes of the present invention also include aluminoxanes (or alumoxanes) and aluminum alkyls. Without being bound by theory, an alumoxane is typically believed to be an oligomeric aluminum compound represented by the general formula (Rx-Al—O)n, which is a cyclic compound, or Rx (Rx-Al—O)nAlRx₂, which is a linear compound. Most commonly, alumoxane is believed to be a mixture of the cyclic and linear compounds. In the general alumoxane formula, Rx is independently a C₁-C₂₀ alkyl radical, for example, methyl, ethyl, propyl, butyl, pentyl, isomers thereof, and the like, and n is an integer from 1-50. In any embodiment, Rx may be methyl and n may be at least 4. Methyl alumoxane (MAO), as well as modified MAO containing some higher alkyl groups to improve solubility, ethyl alumoxane, iso-butyl alumoxane, and the like are useful for the processes disclosed herein.

Further, the catalyst systems suitable for use in the present invention may contain, in addition to the transition metal compound and the activator described above, additional activators (co-activators), and/or scavengers. A co-activator is a compound capable of reacting with the transition metal complex, such that when used in combination with an activator, an active catalyst is formed. Co-activators include alumoxanes and aluminum alkyls.

In any embodiment, scavengers may be used to “clean” the reaction of any poisons that would otherwise react with the catalyst and deactivate it. Typical aluminum or boron alkyl components useful as scavengers are represented by the general formula RxJZ₂ where J is aluminum or boron, Rx is a C₁-C₂₀ alkyl radical, for example, methyl, ethyl, propyl, butyl, pentyl, and isomers thereof, and each Z is independently Rx or a different univalent anionic ligand such as halogen (C₁, Br, I), alkoxide (ORx), and the like. Exemplary aluminum alkyls include triethylaluminum, diethylaluminum chloride, ethylaluminium dichloride, tri-iso-butylaluminum, tri-n-octylaluminum, tri-n-hexylaluminum, trimethylaluminum, and combinations thereof. Exemplary boron alkyls include triethylboron. Scavenging compounds may also be alumoxanes and modified alumoxanes including methylalumoxane and modified methylalumoxane.

### Solvents for Preparing PBPs

The solvent used in the reaction system of the present invention may be any non-polymeric species capable of being removed from the polymer composition by heating to a temperature below the decomposition temperature of the polymer and/or reducing the pressure of the solvent/polymer mixture. In any embodiment, the solvent may be an aliphatic or aromatic hydrocarbon fluid.

Examples of suitable, preferably inert, hydrocarbon fluids are readily volatile liquid hydrocarbons, which include, for example, hydrocarbons containing from 1 to 30, preferably 3 to 20, carbon atoms. Preferred examples include propane, n-butane, isobutane, mixed butanes, n-pentane, isopentane, neopentane, n-hexane, cyclohexane, isohexane, octane, other saturated C₆ to C₈ hydrocarbons, toluene, benzene, ethylbenzene, chlorobenzene, xylene, desulphurized light virgin naphtha, and any other hydrocarbon solvent recognized by those skilled in the art to be suitable for the purposes of this invention. Particularly preferred solvents for use in the processes disclosed herein are n-hexane and toluene.

The optimal amount of solvent present in combination with the polymer at the inlet to the devolatilizer will generally be dependent upon the desired temperature change of the polymer melt within the devolatilizer, and can be readily determined by persons of skill in the art. For example, the polymer composition may comprise, at the inlet of the devolatilizer, from about 1 wt % to about 50 wt % solvent, or from about 5 wt % to about 45 wt % solvent, or from about 10 wt % to about 40 wt % solvent, or from about 10 wt % to about 35 wt % solvent.

International Publication No. 2013/134038 generally describes the catalysts, activators, and solvents used to prepare the polymer blend used in the fiber compositions. The contents of International Publication No. 2013/134038 and its parent application U.S. Patent Application No. 61/609,020 filed Mar. 9, 2012, are both incorporated herein in their entirety.

### Block Copolymer Component

In an embodiment, the compositions described herein comprises less than or equal to about 30 wt % of a block copolymer component. In an embodiment, the composition comprises less than or equal to about 20 wt %, or 15 wt %, or 10 wt %, or 5 wt %, or 2 wt %, or 1 wt %, or 0.1 wt % of a block copolymer. In an embodiment, the composition may be free of, or comprise less than 0.01 wt % of a block copolymer. As used herein, a composition is free of a particular ingredient if it contains less than 0.1 wt % of the particular ingredient by total weight of the composition. As used herein in one embodiment, a composition is essentially free of block copolymer if the block copolymer is present in such minor amounts that the clear visual determination described below is still obtained. The composition in one embodiment consists essentially of the propylene-based polymer component and optionally, other ingredients and additives, such that the clear visual determination is not adversely impacted. In an embodiment, the composition may be free of, or comprise less than 1 wt % of a block copolymer comprising styrene, also referred to in the art as a styrenic block copolymer. For purposes herein, the phrase “block copolymer” includes any manner of block copolymer having two or more polymer chains attached at their ends, including but not limited to diblock, triblock, and tetrablock copolymers. “Block copolymer” is further meant to include copolymers having any structure known to those of skill in the art, including but not limited to linear, radial or multi-arm star, multi-branched block copolymers, and random block copolymers. “Linear block copolymers” comprise two or more polymer chains in sequence. “Radial block copolymers” (or “star block copolymers”) comprise more than two linear block copolymers attached at a common branch point. “Styrenic block copolymers” comprise a block copolymer having at least one block that is greater than 50% styrene. For purposes herein, block copolymers may be linear or radial, or combinations of linear and radial block copolymers. The block copolymers may or may not be hydrogenated.

Block copolymers comprising styrene include linear block copolymers of styrene and one or more conjugated dienes such as SI (styrene-isoprene), SIS (styrene-isoprene-styrene), SB (styrene-butadiene), SBS (styrene-butadiene-styrene), SIB (styrene-isoprene-butadiene), or combination thereof.

Block copolymers also include tetrablock or pentablock copolymers selected from A-B-A-B tetrablock copolymers or A-B-A-B-A pentablock copolymers and the like are also suitable such as SISI (styrene-isoprene-styrene-isoprene), SISB, SBSB, SBSI, SIBS, ISISI, ISISB, BSISB, ISBSI, BSBSB, and BSBSI block copolymers.

In one or more embodiments, the composition may include less than 30 wt %, or may be free of, or comprise less than about 0.01 wt % of linear block copolymer includes a linear polymer of the formula S—I—S or S—B—S, wherein S is substantially a polystyrene block, I is substantially a polyisoprene block, and B is substantially a polybutadiene block. The styrene content of the SBS block copolymer is typically from about 10 to about 45 wt %, or from about 15 to about 35 wt %, or from about 20 to 30 wt %. The SIS block copolymers may be prepared by well-known anionic solution polymerization techniques using lithium-type initiators such as disclosed in U.S. Pat. Nos. 3,251,905 and 3,239,478, which are hereby incorporated by reference in their entireties. The SIS and the SBS copolymer may be a pure triblock (one having less than 0.1 wt % of diblock polymer, preferably 0% diblock polymer), or may contain from about 0.1 to about 85 wt %, or from about 0.1 to about 75 wt %, or from about 1 to about 65 wt %, or from about 5 to about 50 wt %, or from 5 to 25 wt %, or from 10 to 20 wt % diblock copolymer having the structure S—I or SB, respectively. The SI or SB diblock may be present as a residue from the manufacture of the triblock copolymer or may be separately blended with the triblock as a further technique for achieving target polystyrene content or modifying the cohesive properties of the composition. In one or more embodiments, the number average molecular weight of the diblock SI copolymers may range from about 100,000 to about 250,000.

### Hydrocarbon Tackifier Component

In one or more embodiments the adhesive compositions described herein comprise a hydrocarbon tackifier resin component, which may in turn comprise one or more hydrocarbon tackifier resins.

Hydrocarbon tackifier resins suitable for use according to one or more embodiments of the instant disclosure include, but are not limited to, aliphatic hydrocarbon resins, at least partially hydrogenated aliphatic hydrocarbon resins, aliphatic/aromatic hydrocarbon resins, at least partially hydrogenated aliphatic aromatic hydrocarbon resins, aromatic resins, at least partially hydrogenated aromatic hydrocarbon resins, cycloaliphatic hydrocarbon resins, at least partially hydrogenated cycloaliphatic resins, cycloaliphatic/aromatic hydrocarbon resins, cycloaliphatic/aromatic at least partially hydrogenated hydrocarbon resins, polyterpene resins, terpene-phenol resins, rosin esters, rosin acids, grafted resins, and mixtures of two or more of the foregoing. The hydrocarbon tackifiers may be polar or apolar.

In one embodiment, the tackifier component may comprise one or more hydrocarbon resins produced by the thermal polymerization of cyclopentadiene (CPD) or substituted CPD, which may further include aliphatic or aromatic monomers as described later. The hydrocarbon resin may be a non-aromatic resin or an aromatic resin. The hydrocarbon resin may have an aromatic content between 0 wt % and 60 wt %, preferably between 1% and 60%, or between 1% and 40%, or between 1% and 20%, or between 10% and 20%. In further embodiments, the hydrocarbon resin may have an aromatic content between 15% and 20%, or between 1% and 10%, or between 5% and 10%.

In another embodiment, the tackifier component may comprise hydrocarbon resins produced by the catalytic (cationic) polymerization of linear dienes. Such monomers are primarily derived from Steam Cracked Naptha (SCN) and include C₅ dienes such as piperylene (also known as 1,3-pentadiene). Polymerizable aromatic monomers can also be used to produce resins and may be relatively pure, e.g., styrene, -methyl styrene, or from a C₉-aromatic SCN stream. Such aromatic monomers can be used alone or in combination with the linear dienes previously described. “Natural” monomers can also be used to produce resins, e.g., terpenes such as alpha-pinene or beta-carene, either used alone or in high or low concentrations with other polymerizable monomers. Typical catalysts used to make these resins are A₁C₁₃ and BF₃, either alone or complexed. Mono-olefin modifiers such as 2-methyl, 2-butene may also be used to control the molecular weight distribution (MWD) of the final resin. The final resin may be partially or totally hydrogenated as described in further detail herein.

As used herein, aromatic content and olefin content are measured by 1H-NMR, as measured directly from the 1H NMR spectrum from a spectrometer with a field strength greater than 300 MHz, preferably 400 MHz. Aromatic content is the integration of aromatic protons versus the total number of protons. Olefin proton or olefinic proton content is the integration of olefinic protons versus the total number of protons.

In one or more embodiments, the resin may be at least partially hydrogenated or substantially hydrogenated. As used herein, “at least partially hydrogenated” means that the material contains less than 90% olefinic protons, or less than 75% olefinic protons, or less than 50% olefinic protons, or less than 40% olefinic protons, or less than 25% olefinic protons. As used herein, “substantially hydrogenated” means that the material contains less than 5% olefinic protons, or less than 4% olefinic protons, or less than 3% olefinic protons, or less than 2% olefinic protons. The degree of hydrogenation is typically conducted so as to minimize and preferably avoid hydrogenation of the aromatic bonds.

In one or more embodiments, hydrocarbon tackifier resins described herein may be uniquely characterized as totally or substantially amorphous in nature. This means that a glass transition temperature (Tg) is detectable, e.g., by Differential Scanning calorimetry (DSC), but they have no melting point (Tm). To characterize these resins, it is generally accepted to use a test that roughly correlates with Tg, such as softening point (SP), which provides approximate, but not exact, values. The softening point (SP) of the resins is measured by a ring-and-ball softening point test according to ASTM E-28.

In some embodiments, the hydrocarbon resin may have a ring and ball softening point of from about 50° C. to about 150° C., or from about 60° C. to about 130° C., or from about 70° C. to about 120° C., or from about 80° C. to about 110° C., determined according to ASTM E-28 or an equivalent thereof.

In one or more embodiments of the invention, the hydrocarbon resin has a number average molecular weight (Mn) from about 400 to about 3000, a weight average molecular weight (Mw) from about 500 to about 6000, a z-average molecular weight (Mz) from about 700 to about 30,000 and a polydispersity (PD), defined as Mw/Mn, between about 1.5 and about 4. As used herein, molecular weights (number average molecular weight (Mn), weight average molecular weight (Mw), and z-average molecular weight (Mz)) are measured by size exclusion chromatography using a Waters 150 Gel Permeation Chromatograph equipped with a differential refractive index detector and calibrated using polystyrene standards. Samples are run in tetrahydrofuran (THF) (45° C.). Molecular weights are reported as polystyrene-equivalent molecular weights and are generally measured in g/mol.

In an embodiment, the hydrocarbon tackifier resin component may comprise one or more oligomers such as dimers, trimers, tetramers, pentamers, and hexamers. The oligomers may be derived from a petroleum distillate boiling in the range of 30-210° C. The oligomers may be derived from any suitable process and are often derived as a byproduct of resin polymerization. Suitable oligomer streams may have molecular weights (Mn) between 130-500, more preferably between 130-410, more preferably between 130-350, or between 130-270, or between 200-350, or between 200-320. Examples of suitable oligomer streams include, but are not limited to, oligomers of cyclopentadiene and substituted cyclopentadiene, oligomers of C₄-C₆ conjugated diolefins, oligomers of C₈-C₁₀ aromatic olefins, and combinations thereof. Other monomers may be present. These include C₄-C₆ mono-olefins and terpenes. The oligomers may comprise one or more aromatic monomers and may be at least partially hydrogenated or substantially hydrogenated.

In an embodiment, the oligomers may be stripped from the resin before hydrogenation. The oligomers may also be hydrogenated with the resin and then stripped from the resin, yielding a hydrogenated resin and hydrogenated oligomers. In another embodiment, at least some of the oligomers are stripped before hydrogenation and at least some hydrogenated oligomers are stripped after hydrogenation. In yet another embodiment, the hydrogenated resin/oligomers product may be further processed together as a single mixture as described below. In yet another embodiment, the oligomers can be derived from any suitable source and hydrogenated (if necessary) before grafting so that the oligomers before grafting are typically at least partially hydrogenated and preferably substantially hydrogenated.

The hydrocarbon tackifier resin component may comprise one or more hydrocarbon tackifier resins. When the composition comprises a finite amount of a block copolymer, these resins may be chosen based upon their compatibility with the one or more block copolymers which comprise the block copolymer component of the adhesive composition. For example, certain tackifier resins may be better suited for use with SIS block copolymers, while other tackifier resins may be more compatible with SBS block copolymers.

Examples of commercially available SIS compatible tackifier resins include, but are not limited to, ESCOREZ 2203LC, ESCOREZ 1310LC, ESCOREZ 1304, ESCOREZ 5380, and ESCOREZ 5600, manufactured by ExxonMobil Chemical Company; Piccotac 1905 and EASTOTAC H-100, manufactured by Eastman Chemicals; QUINTONE D and QUINTONE U 185, manufactured by Nippon Zeon; MARUKARES R100, manufactured by Maruzen; and WINGTACK EXTRA and WINGTACK PLUS, manufactured by Cray Valley.

Examples of commercially available SBS compatible tackifier resins include, but are not limited to, ESCOREZ 2101, ESCOREZ 5690, and ESCOREZ 2173, manufactured by ExxonMobil Chemical Company; Regalrez 5095, Regalrez 3102, Staybelite Ester 3, and Pentalyn H, manufactured by Eastman Chemicals; Quintone U 190, manufactured by Nippon Zeon; Wingtack 86, manufactured by Cray Valley; and Sylvalite RE 885 and Sylvatac RE 85, available from Arizona Chemical.

In one or more embodiments, the hot melt pressure-sensitive adhesive compositions described herein may comprise from about 1 to about 50 wt %, or from about 5 to about 45%, or from about 10 to about 40 wt %, or from about 15 to about 35 wt % of the hydrocarbon tackifier resin component, based on the total weight of the composition.

### Process Oil Component

In one or more embodiments according to the instant disclosure, one or more process oils may be added to the hot melt pressure-sensitive adhesive compositions described herein. As used herein, the term “process oil” means both petroleum derived process oils and synthetic plasticizers.

Examples of process oils suitable for use herein include, but are not limited to, paraffinic or naphthenic oils such as Primol 352 or Core 600 fluid, produced by ExxonMobil Chemical France; and Nyflex 222B, available from Nynas AB.

Further process oils suitable for use herein include aliphatic naphthenic oils, white oils, and the like. Exemplary plasticizers and/or adjuvants include mineral oils, polybutenes, phthalates and the like. In one or more embodiments, the plasticizers may include phthalates such as diisoundecyl phthalate (DIUP), diisononylphthalate (DINP), dioctylphthalates (DOP), and polybutenes, such as Parapol 950 and Parapol 1300 available from ExxonMobil Chemical Company in Houston, Tex. Further useful plasticizers include those described in International Patent Application No. WO 01/18109A1 and U.S. Application Publication No. 2004/0106723, which are incorporated by reference herein.

In one or more embodiments, the hot melt pressure-sensitive adhesive compositions described herein may comprise from about 1 to about 50 wt %, or from about 5 to about 40 wt %, or from about 10 to about 35 wt %, or from about 15 to about 30 wt % of the optional process oil component.

### Other Additives and Fillers

In some embodiments, one or more additional fillers or additives may be employed to achieve the properties and characteristics desired in the final adhesive formulation. Such additive and fillers are known in the art and may include, but are not limited to fillers, cavitating agents, antioxidants, surfactants, adjuvants, plasticizers, block, antiblock, colorants, color masterbatches, pigments, dyes, processing aids, UV stabilizers, neutralizers, lubricants, waxes, and/or nucleating agents. The additives may be present in any amount determined to be effective by those skilled in the art, such as for example from about 0.001 wt % to about 10 wt %.

Examples of suitable antioxidants include, but are not limited to, quinolein, e.g., trimethylhydroxyquinolein (TMQ); imidazole, e.g., zincmercapto toluoyl imidazole (ZMTI); and conventional antioxidants, such as hindered phenols, lactones, phosphates, and hindered amines. Further suitable anti-oxidants are commercially available from, for example, Ciba Geigy Corp. under the trade names Irgafos 168, Irganox 1010, Irganox 3790, Irganox B225, Irganox 1035, Irgafos 126, Irgastab 410, and Chimassorb 944.

Fillers, cavitating agents, and/or nucleating agents suitable for use herein may comprise granular, fibrous, and powder-like materials, and may include, but are not limited to, titanium dioxide, calcium carbonate, barium sulfate, silica, silicon dioxide, carbon black, sand, glass beads, mineral aggregates, talc, natural and synthetic clays, diatomaceous earth, and the like.

Processing aids, lubricants, waxes, and/or oils (e.g., oils described above) which may be employed in embodiments of the adhesive compositions disclosed herein include low molecular weight products such as wax, oil, or low Mn polymer (low meaning having an Mn less than 5000, preferably below 4000, or below 3000, or below 2500). Waxes may include polar or non-polar waxes, functionalized waxes, polypropylene waxes, polyethylene waxes, and wax modifiers.

The additives described herein can be added to the blend in pure form or in master batches.

In one or more embodiments, the adhesive compositions described herein may comprise one or more process oils as described above, but are otherwise substantially free of silicon oils or waxes. In an embodiment, the composition is removable and free of silicon oils and waxes, or in an embodiment comprises less than 0.01 wt % of a silicon oil and wax. By “substantially free of” is meant that any silicon oils or waxes in the adhesive composition are present as impurities only; no silicon oils or waxes are deliberately added to the adhesive formulation. In an embodiment, the composition is removable and comprises less than 0.01 wt % of a silicon oil and/or a silicon wax. In an embodiment of the invention, the composition is substantially free of a functional component, wherein the functional component has at least 0.1 wt % of a functional group.

For purposes herein, an adhesive composition or an article comprising an adhesive composition is removable wherein the adhesive or the article comprising the adhesive can be applied to a surface and easily removed without leaving a substantial amount or without leaving any, or a substantial amount of residue as is commonly understood by one having minimal skill in the art. In an embodiment, the adhesive or the article comprising the adhesive is removable when it can be applied to a surface and easily removed leaving less than 0.1% of the adhesive originally present on the surface, based on the total amount of adhesive originally applied.

### Preparation of the Hot Melt Pressure-Sensitive Adhesive Composition

In one or more embodiments, the components of the hot melt pressure-sensitive adhesive compositions described herein may be blended by mixing, using any suitable mixing device at a temperature above the melting point of the components, e.g., at 130 to 180° C., for a period of time sufficient to form a homogeneous mixture, normally from about 1 to about 120 minutes depending on the type of mixing device.

In the case of continuous mixing as practiced by most commercial manufacturers, a twin screw extruder may be used to mix the adhesive components. First the propylene-based polymer components and block copolymers when present are introduced into the extruder and mixed until the polymers have melted and are well mixed. Then the tackifiers are added, followed by any process oils which may be desired. To the extent pigments, antioxidants, fillers, or other additives are used, they are normally blended in with the propylene-based polymer components. The total mixing time is typically on the order of from about 1 to 5 minutes.

In the case of batch mixing, the propylene-based polymer component or components are added along with less than or equal to about 20% of the tackifier component. When the polymers and tackifier reach a homogeneous state, the remaining tackifier component is gradually added to the mix. Once all of the tackifier components have been added and homogeneous mix is achieved, the balance of the process oil, antioxidants, fillers, and any other additives are added. The total mixing time may run for up to 120 minutes.

### Adhesive Articles

In one or more embodiments adhesive tapes may be formed which comprise a substrate coated with one or more adhesive compositions as described herein. As used herein, the term “tape” is meant generically to encompass any manner of adhesive application, including but not limited to tapes, labels, stickers, decals, packaging applications, and the like. In an embodiment, the adhesive tape is removable as described herein.

The adhesive compositions described herein may be applied to any substrate. Suitable substrates may include, but are not limited to, wood, paper, cardboard, plastic, plastic film, thermoplastic, rubber, metal, metal film, metal foil (such as aluminum foil and tin foil), metallized surfaces, cloth, non-wovens (particularly polypropylene spunbonded fibers or non-wovens), spunbonded fibers, cardboard, stone, plaster, glass (including silicon oxide (SiOx) coatings applied by evaporating silicon oxide onto a film surface), foam, rock, ceramics, films, polymer foams (such as polyurethane foam), substrates coated with inks, dyes, pigments, PVDC and the like or combinations thereof. Additional substrates may include polyethylene, polypropylene, polyacrylates, acrylics, polyethylene terephthalate, or blends thereof. Corona treatment, electron beam irradiation, gamma irradiation, microwave or silanization may modify any of the above substrates.

The adhesive compositions of this invention may be applied to a substrate as a melt and then cooled. The adhesive composition may be applied to a substrate using conventional coating techniques such as spraying, roller coaters, die coaters and/or blade coaters, generally at a temperature of from about 150° C. to about 200° C. In one or more embodiments, the adhesive composition is applied to a substrate using a slot die.

A slot die is a closed system where an adhesive composition is pumped through the system via a positive displacement pump. The slot die usually includes a rotating bar at the point of the outlet of the adhesive in order to maintain a smooth surface.

The substrate should be coated with sufficient adhesive composition to provide a dry coating weight of from about 10 to about 100, or from about 10 to about 50, or from about 15 to about 25 grams per square meter (g/m²).

After coating, the coated substrate is cut to the required dimension. In the manufacture of tape, the substrate is slit into strips and rolled into a finished product. The substrate may also be cut into shaped items to provide labels. In one or more embodiments, a release liner may also be employed if desired.

### Properties of the Adhesive Composition

In one or more embodiments, the hot melt pressure-sensitive adhesive compositions described herein may comprise from 45 wt % to 99 wt %, or greater than or equal to about 50 wt %, or 60 wt %, or 70 wt %, or 80 wt %, or 90 wt % or 95 wt % of the propylene-based polymer component. In embodiments, the hot melt pressure-sensitive adhesive compositions described herein consist essentially of the propylene-based polymer component, or consist essentially of the propylene-based polymer component and the hydrocarbon tackifier resin, or consist essentially of the propylene-based polymer component, the hydrocarbon tackifier resin, and the process oil, or consist essentially of the propylene-based polymer component, and one or more of the hydrocarbon tackifier resin component, the process oil component, and one or more additional fillers and/or additives including, but are not limited to fillers, cavitating agents, antioxidants, surfactants, adjuvants, plasticizers, block, antiblock, colorants, color masterbatches, pigments, dyes, processing aids, UV stabilizers, neutralizers, lubricants, waxes, and/or nucleating agents as described herein.

In an embodiment, the compositions comprise a hot melt pressure-sensitive adhesive which is free of a block copolymer component, or which comprises less than about 0.01 wt % of a block copolymer.

In an embodiment, the compositions comprise a hot melt pressure-sensitive adhesive comprising from about 1 to about 20 wt % of the hydrocarbon tackifier component. In an embodiment, the compositions comprise a hot melt pressure-sensitive adhesive comprising from about 1 to 30 wt % of a process oil.

In one or more embodiments, the initial 180° peel strength of the adhesive tape compositions described herein when adhered to steel is less than or equal to about 10, or less than or equal to about 8, or less than or equal to about 6, or less than or equal to about 4 N/25 mm (at a coating weight of about 20 g/m²). In an embodiment, the initial 180° peel strength of an adhesive tape on glass of from 0.1 to about 10 N/25 mm at a coating weight of 20 g/m². In an embodiment, an initial 180° peel strength of an adhesive tape on polyethylene film of from 0.1 to about 10 N/25 mm at a coating weight of 20 g/m². In the same or other embodiments, the initial 180° peel strength of the adhesive tape compositions described herein when adhered to glass is less than or equal to about 10, or less than or equal to about 5, or less than or equal to about 4, or less than or equal to about 3 N/25 mm (at a coating weight of about 20 g/m²). In the same or other embodiments, the initial 180° peel strength of the adhesive tape compositions described herein when adhered to polyethylene film is less than or equal to about 10, or less than or equal to about 5, or less than or equal to about 3, or less than or equal to about 2 N/25 mm (at a coating weight of about 20 g/m²).

In one or more embodiments, the 180° peel strength of the adhesive tape compositions described herein after one week incubation at 60° C. when adhered to steel is less than or equal to about 35, or less than or equal to about 30, or less than or equal to about 25, or less than or equal to about 20 N/25 mm (at a coating weight of about 20 g/m²). In the same or other embodiments, the 180° peel strength of the adhesive tape compositions described herein after one week incubation at 60° C. when adhered to glass is less than or equal to about 30, or less than or equal to about 25, or less than or equal to about 20, or less than or equal to about 15 N/25 mm (at a coating weight of about 20 g/m²). In the same or other embodiments, the 180° peel strength of the adhesive tape compositions described herein after one week incubation at 60° C. when adhered to polyethylene film is less than or equal to about 15, or less than or equal to about 10, or less than or equal to about 8, or less than or equal to about 6 N/25 mm (at a coating weight of about 20 g/m²).

As used herein, the 180° peel strength of a sample is determined according to FINAT testing method 1 (FTM 1).

In one or more embodiments, the shear of the adhesive tapes described herein when adhered to steel (25 mm*25 mm, 1 kg) at room temperature (23° C.+−0.2° C., 50%.+−0.5% RH) is greater than or equal to about 10 hours, or greater than or equal to about 15 hours, or greater than or equal to about 20 hours. As used herein, shear is determined by FINAT testing method 8 (FTM 8).

In an embodiment, the compositions comprise a hot melt pressure-sensitive adhesive having a clear visual determination such that the compositions are suitable for use in no-label look labels. While a number of determinations are suitable for determining a visually clear composition, the instant compositions do not lend themselves to standard testing methods directed to clarity due to the difficulty in providing a sample with a uniform thickness for spectroscopic testing. Accordingly, the following test is used to determine the visual clarity of the instant compositions, which allows for an objective determination of visual clarity sufficient for use as a no-label look label, or the like. In an embodiment, the composition has a clear visual determination, wherein the visual determination consists of providing a testing square consisting of a piece of white 20 weight paper having a brightness of 90%. The paper may have a higher weight, and 20 pound weight paper should be considered the minimum for use. Likewise, the paper may have a higher brightness, and 90% brightness should be considered the minimum brightness. The testing square having a printed portion comprising the capital letters “O” and “Q” printed with a laser printer to be visually distinguishable at 1 space apart from each other thereon in black print using Helvetica number 10 font; depositing a sample of the composition at a temperature above the melting point of the composition onto the testing square using a flat applicator to cover the printed portion of the testing square with a film of the composition having a thickness of 1 mm, followed by allowing the composition to cool to a temperature of 25° C. to produce a prepared test sample. The thickness may be greater than 1 mm, and should be at least 1 mm. Accordingly, a thickness of 1 mm to 5 mm may be acceptable, since clarity at greater than 1 mm, e.g., 5 mm, would indicate clarity at 1 mm. The method then includes visually determining the clarity of the prepared test sample wherein the prepared test sample has a clear visual determination when an observer having essentially 20:20 vision is able to visually distinguish the letter “O” from the letter “Q” in the printed portion of the testing square at a distance of about 30 cm from the prepared test sample at an illumination of at least 1000 lux, which should be considered the minimum, with an illumination from 1000 lux to 2000 lux being acceptable.

For purposes herein, a piece of white 20 pound or higher weight paper having a brightness of greater than 90% is exemplified by standard copier or printer paper as generally known in the art and which is readily available. For purposes herein the testing square having a printed portion comprising the capital letters “O” and “Q” printed with a laser printer to be visually distinguishable at 1 space apart from each other thereon in black ink using Helvetica number 10 font refers to a printing utilizing a typical laser printer e.g., an HP LaserJet™ or the like, utilizing black toner or ink (black print) to produce a black image on a white background in which the letters 0 and Q are printed such that the letters are readily distinguishable by an observer having about 20/20 vision at a distance of about 30 cm between the observer and the testing sample. Accordingly, the test involves the ability for an observer having 20/20 vision, or vision corrected to be essentially 20/20 being able to discern the letter O from the letter Q at a typical reading distance in an environment having an amount of illumination suitable for reading (i.e., at an illumination of from 1000 lux to 2000 lux).).

The Helvetica font refers to the font developed in 1957 by Max Miedinger with Eduard Hoffmann at the Haas'sche Schriftgiesserei (Haas Type Foundry) of Münchenstein, Switzerland, a new sans-serif typeface originally referred to as Neue Haas Grotesk, and based on the Normal Grotesk of Schelter-Grotesk and Haas. In 1960, the name of the typeface was changed to Helvetica. For purposes herein, the capital letters “O” and “Q” printed using 10-point Helvetica font are defined as the same printed using a common laser printer on plain copier paper as described herein, as is readily understood by one having minimal skill in the art.

The deposit of the sample of the composition is conducted at a temperature above the melting point of the composition, typically between about 60 and 180° C. onto the testing square using a flat applicator to cover the printed portion of the testing square with a film of the composition having a thickness of 1 mm to 5 mm, followed by allowing the composition to cool to a temperature of 25° C. to produce a prepared test sample. By specifying a minimum thickness of 1 mm (i.e., a thickness of 1 mm to 5 mm), the difficulty in producing a sample for observation is overcome since a clear visual determination at a greater thickness implies that a clear visual determination would be obtained at a thickness of 1 mm. The flat applicator may be a spatula or the like, and the molten composition is simply spread over the letters on the testing square and allowed to cool to determine the clarity of the composition. A clear visual determination represents the ability of an observer having essentially 20:20 vision is able to visually distinguish the letter “O” from the letter “Q” in the printed portion of the testing square at a distance of about 30 cm from the prepared test sample at an illumination of from 1000 lux to 2000 lux. A hazy or not clear determination occurs when the letter “O” cannot be distinguished from the letter “Q” in the printed portion of the testing square at a distance of about 30 cm from the prepared test sample at an illumination of from 1000 lux to 2000 lux.

Inherent in the above test is a sample essentially free of bubbles and which is fully mixed and homogeneous over the printed test area.

In an embodiment, the instant adhesive compositions show improved solvent resistance in label applications. Typical adhesive compositions are readily soluble in aromatic organic solvents, and are typically dissolved at 50 wt % in toluene for color determination and the like. In contrast, the adhesive compositions disclosed herein, comprising the propylene-based polymer component and less than 30 wt % of a block copolymer, are not readily soluble in toluene. In an embodiment, the propylene-based polymer component has a solubility in toluene of less than 50 wt %, or 40 wt %, or 30 wt %, or wt %, or 10 wt % at 25° C. The propylene-based polymer component simply “gels” in toluene, and is not readily soluble therein. This attribute of the adhesive results in an adhesive having improved solvent resistance as compared to adhesives which are soluble in toluene at 50 wt % or above at 25° C.

In an embodiment, the adhesive composition is clear colorless, having an APHA of less than 10, determined according to ASTM D1209 or an equivalent thereof, wherein APHA is a single number yellowness index where each APHA unit is based on a dilution of the 500 ppm stock solution of PtCo. Distilled water has an APHA value of zero. The stock solution has an APHA value of 500. The PtCo scale and Hazen scale are also based on this sample reagent dilution and have units equivalent to APHA units.

Further embodiments according to the instant disclosure are described with reference to the following lettered paragraphs:

Paragraph A: A hot melt pressure-sensitive adhesive composition comprising a propylene-based polymer component, wherein the propylene-based polymer component comprises a first propylene-based polymer wherein the first propylene-based polymer is a homopolymer of propylene or a copolymer of propylene and ethylene or a C₄ to C₁₀ alpha-olefin and a second propylene-based polymer wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min; and wherein the hot melt pressure-sensitive adhesive composition is free of or comprises not more than about 30 wt % of a block copolymer based on the weight of the hot melt pressure sensitive adhesive composition.

Paragraph B: The hot melt pressure-sensitive adhesive composition of Paragraph A, wherein the propylene-based polymer component has an Mw of about 10,000 g/mol to about 150,000 g/mol.

Paragraph C: The hot melt pressure-sensitive adhesive composition of Paragraph A and/or B, wherein the propylene-based polymer component is a dual reactor blend.

Paragraph D: The hot melt pressure-sensitive adhesive composition of any one or any combination of Paragraphs A to C, wherein the propylene-based polymer component is a solution blend.

Paragraph E: The hot melt pressure-sensitive adhesive composition of any one or any combination of Paragraphs A to D, wherein the first propylene-based polymer of the propylene-based polymer component comprises a copolymer of propylene and ethylene, and the second propylene-based polymer of the propylene-based polymer component comprises a copolymer of propylene and ethylene.

Paragraph F: The hot melt pressure-sensitive adhesive composition of any one or any combination of Paragraphs A to E, wherein the first propylene-based polymer of the propylene-based polymer component and the second propylene-based propylene polymer of the propylene-based polymer component have a difference in heat of fusion of at least 10 J/g.

Paragraph G: The hot melt pressure-sensitive adhesive composition of any one or any combination of Paragraphs A to F, wherein the propylene-based polymer component has a melt viscosity of about 800 to about 15,000 cP at 190° C.

Paragraph H: The hot melt pressure-sensitive adhesive composition of any one or any combination of Paragraphs A to G, comprising less than 0.01 wt % of the block copolymer.

Paragraph I: The hot melt pressure-sensitive adhesive composition of any one or any combination of Paragraphs A to H, comprising less than 0.01 wt % of a block copolymer comprising styrene.

Paragraph J: The hot melt pressure-sensitive adhesive composition of any one or any combination of Paragraphs A to I, comprising from about 1, to about 60 wt % of a hydrocarbon tackifier resin based on the weight of the hot melt pressure sensitive adhesive.

Paragraph K: The hot melt pressure-sensitive adhesive composition of Paragraph J, wherein the hydrocarbon tackifier resin has a ring-and-ball softening point of from about 50 to about 150° C.

Paragraph L: The hot melt pressure-sensitive adhesive composition of any one or any combination of Paragraphs A to K, comprising from about 1 to about 30 wt % of a process oil based on the weight of the hot melt pressure-sensitive adhesive.

Paragraph M: The hot melt pressure-sensitive adhesive composition of any one or any combination of Paragraphs A to L, wherein the hot melt pressure-sensitive adhesive composition is a removable hot melt pressure-sensitive adhesive and wherein the hot melt pressure-sensitive adhesive composition comprises less than 0.01 wt % total of silicon oils and waxes.

Paragraph N: The hot melt pressure-sensitive adhesive composition of any one or any combination of Paragraphs A to M, having a clear visual determination, wherein the visual determination consists of providing a testing square consisting of a piece of white 20 pound weight paper having a brightness of 90%, the testing square having a printed portion comprising the capital letters “O” and “Q” printed with a laser printer to be visually distinguishable at 1 space apart from each other thereon in black text using 10-point Helvetica font; depositing a sample of the hot melt pressure-sensitive adhesive composition at a temperature above the melting point of the hot melt pressure-sensitive adhesive composition onto the testing square using a flat applicator to cover the printed portion of the testing square with a film of the hot melt pressure-sensitive adhesive composition having a thickness of 1 mm, followed by allowing the hot melt pressure-sensitive adhesive composition to cool to a temperature of 25° C. to produce a prepared test sample; and visually determining the clarity of the prepared test sample wherein the prepared test sample has a clear visual determination when an observer having essentially 20:20 vision is able to visually distinguish the letter “O” from the letter “Q” in the printed portion of the testing square at a distance of about 30 cm from the prepared test sample at an illumination of 1000 lux.

Paragraph O: An adhesive article comprising a substrate and a hot melt pressure-sensitive adhesive composition comprising a propylene-based polymer component, wherein the propylene-based polymer component comprises a first propylene-based polymer wherein the first propylene-based polymer is a homopolymer of propylene or a copolymer of propylene and ethylene or a C₄ to C₁₀ alpha-olefin and a second propylene-based polymer wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min; and wherein the adhesive composition free of or comprising less than about 30 wt % of a block copolymer based on the weight of the hot melt pressure-sensitive adhesive.

Paragraph P: The adhesive article of Paragraph O, wherein the propylene-based polymer component has a melt viscosity of about 800 to about 15,000 cP at 190° C.

Paragraph Q: The adhesive article of Paragraph O and/or P, wherein the hot melt pressure-sensitive adhesive composition comprises from about 1 to about 60 wt % of a hydrocarbon tackifier resin based on the weight of the hot melt pressure-sensitive adhesive.

Paragraph R: The adhesive article of any one or any combination of Paragraphs O to Q, wherein the hydrocarbon tackifier resin has a ring-and-ball softening point of from about 50 to about 150° C.

Paragraph S: The adhesive article of any one or any combination of Paragraphs O to R, wherein the hot melt pressure-sensitive adhesive composition comprises less than about 0.01 wt % of the block copolymer.

Paragraph T: The adhesive article of any one or any combination of Paragraphs O to S, wherein the adhesive composition has a clear visual determination, wherein the visual determination consists of providing a testing square consisting of a piece of white 20 pound weight paper having a brightness of 90%, the testing square having a printed portion comprising the capital letters “O” and “Q” printed with a laser printer to be visually distinguishable at 1 space apart from each other thereon in black text using 10-point Helvetica font; depositing a sample of the composition at a temperature above the melting point of the composition onto the testing square using a flat applicator to cover the printed portion of the testing square with a film of the composition having a thickness of 1 mm, followed by allowing the composition to cool to a temperature of 25° C. to produce a prepared test sample; and visually determining the clarity of the prepared test sample wherein the prepared test sample has a clear visual determination when an observer having essentially 20:20 vision is able to visually distinguish the letter “O” from the letter “Q” in the printed portion of the testing square at a distance of about 30 cm from the prepared test sample at an illumination of 1000 lux.

Paragraph U: The adhesive article of any one or any combination of Paragraphs O to T, wherein the adhesive article is an adhesive tape having an initial 180° peel strength of the tape on glass of from 0.1 to about 10 N/25 mm at a coating weight of 20 g/m2.

Paragraph V: The adhesive article of any one or any combination of Paragraphs O to U, wherein the adhesive article is an adhesive tape having an initial 180° peel strength of the tape on polyethylene film of from 0.1 to about 10 N/25 mm at a coating weight of 20 g/m².

### EXAMPLES

The following examples are illustrative of the invention. Materials used in the preparation of the adhesive compositions as identified in the examples are as follows:

| | | |
|---|---|---|
| V4186 | Vector 4186A | Styrenic Block Copolymer (Dexco Polymers) |
| E-5400 | Escorez 5400 | tackifier (ExxonMobil) |
| | Flexon 876 | paraffinic processing oil |
| IRG 1010 | Irganox 1010 | antioxidant |

### Propylene-Based Polymer Components:

| | | | | Shore | | | |
|---|---|---|---|---|---|---|---|
| | Ethylene | Viscosity | | Hard- | | | Estimated |
| | Content | at 190° C. | DH | ness | Tm | Tc | MFR |
| | (wt %) | (cP) | (J/g) | C | (° C.) | (° C.) | (g/10 min) |
| PBP 1 | 11.5 | 7175 | 25 | 25 | 104 | 42 | 2,000 |
| PBP 2 | 12.4 | 4110 | 23 | 29 | 95 | 27 | 3,500 |

Irganox 1010 is a phenolic antioxidant having a melting point from about 110° C. to about 125° C. and a density (at 20° C.) of about 1.15 g/cm³. Irganox 1010 is available from Ciba Specialty Chemicals, Switzerland.

A series of adhesive labels may be prepared by mixing the blend compositions as set forth in Table 1 in a two blade mixer at 145° C. for a period of 70 minutes. The composition can then be heated to a temperature of 175° C. and then pumped through a coating die onto a label paper substrate. The weight of the applied coating layer may range from about 19 to 21 g/m². After coating, the paper may be laminated to a release liner and the resulting adhesive tape can be wound and cut.

The adhesive compositions according to the invention are expected to demonstrate comparative properties to those comprising block copolymer, with improved clarity over the comparative example when the composition is free of the block copolymer. The hot melt PSA (HMPSA) formulations according to the instant disclosure are expected to produce a very clear adhesive when no SIS (block copolymer) was added to formulation.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to various embodiments, other and further embodiments may be devised without departing from the basic scope thereof, and the scope thereof is determined by the claims that follow.

1. A hot melt pressure-sensitive adhesive composition comprising a propylene-based polymer component, wherein the propylene-based polymer component comprises a first propylene-based polymer wherein the first propylene-based polymer is a homopolymer of propylene or a copolymer of propylene and ethylene or a C₄ to C₁₀ alpha-olefin and a second propylene-based polymer wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min; and
wherein the hot melt pressure-sensitive adhesive composition is free of or comprises not more than about 30 wt % of a block copolymer based on the weight of the hot melt pressure sensitive adhesive composition.

2. The hot melt pressure-sensitive adhesive composition of claim 1, wherein the propylene-based polymer component has an Mw of about 10,000 g/mol to about 150,000 g/mol.

3. The hot melt pressure-sensitive adhesive composition of claim 1, wherein the propylene-based polymer component is a dual reactor blend.

4. The hot melt pressure-sensitive adhesive composition of claim 1, wherein the propylene-based polymer component is a solution blend.

5. The hot melt pressure-sensitive adhesive composition of claim 1, wherein the first propylene-based polymer of the propylene-based polymer component comprises a copolymer of propylene and ethylene, and the second propylene-based polymer of the propylene-based polymer component comprises a copolymer of propylene and ethylene.

6. The hot melt pressure-sensitive adhesive composition of claim 1, wherein the first propylene-based polymer of the propylene-based polymer component and the second propylene-based propylene polymer of the propylene-based polymer component have a difference in heat of fusion of at least 10 J/g.

7. The hot melt pressure-sensitive adhesive composition of claim 1, wherein the propylene-based polymer component has a melt viscosity of about 800 to about 15,000 cP at 190° C.

8. The hot melt pressure-sensitive adhesive composition of claim 1, comprising less than 0.01 wt % of the block copolymer.

9. The hot melt pressure-sensitive adhesive composition of claim 1, comprising less than 0.01 wt % of a block copolymer comprising styrene.

10. The hot melt pressure-sensitive adhesive composition of claim 1, comprising from about 1, to about 60 wt % of a hydrocarbon tackifier resin based on the weight of the hot melt pressure sensitive adhesive.

11. The hot melt pressure-sensitive adhesive composition of claim 10, wherein the hydrocarbon tackifier resin has a ring-and-ball softening point of from about 50 to about 150° C.

12. The hot melt pressure-sensitive adhesive composition of claim 1, comprising from about 1 to about 30 wt % of a process oil based on the weight of the hot melt pressure-sensitive adhesive.

13. The hot melt pressure-sensitive adhesive composition of claim 1, wherein the hot melt pressure-sensitive adhesive composition is a removable hot melt pressure-sensitive adhesive and wherein the hot melt pressure-sensitive adhesive composition comprises less than 0.01 wt % total of silicon oils and waxes.

14. The hot melt pressure-sensitive adhesive composition of claim 1, having a clear visual determination, wherein the visual determination consists of providing a testing square consisting of a piece of white 20 pound weight paper having a brightness of 90%, the testing square having a printed portion comprising the capital letters “O” and “Q” printed with a laser printer to be visually distinguishable at 1 space apart from each other thereon in black text using 10-point Helvetica font;
depositing a sample of the hot melt pressure-sensitive adhesive composition at a temperature above the melting point of the hot melt pressure-sensitive adhesive composition onto the testing square using a flat applicator to cover the printed portion of the testing square with a film of the hot melt pressure-sensitive adhesive composition having a thickness of 1 mm, followed by allowing the hot melt pressure-sensitive adhesive composition to cool to a temperature of 25° C. to produce a prepared test sample; and
visually determining the clarity of the prepared test sample wherein the prepared test sample has a clear visual determination when an observer having essentially 20:20 vision is able to visually distinguish the letter “O” from the letter “Q” in the printed portion of the testing square at a distance of about 30 cm from the prepared test sample at an illumination of 1000 lux.

15. An adhesive article comprising a substrate and a hot melt pressure-sensitive adhesive composition comprising a propylene-based polymer component, wherein the propylene-based polymer component comprises a first propylene-based polymer wherein the first propylene-based polymer is a homopolymer of propylene or a copolymer of propylene and ethylene or a C₄ to C₁₀ alpha-olefin and a second propylene-based polymer wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min; and
wherein the adhesive composition free of or comprising less than about 30 wt % of a block copolymer based on the weight of the hot melt pressure-sensitive adhesive.

16. The adhesive article of claim 15, wherein the propylene-based polymer component has a melt viscosity of about 800 to about 15,000 cP at 190° C.

17. The adhesive article of claim 15, wherein the hot melt pressure-sensitive adhesive composition comprises from about 1 to about 60 wt % of a hydrocarbon tackifier resin based on the weight of the hot melt pressure-sensitive adhesive.

18. The adhesive article of claim 15, wherein the hydrocarbon tackifier resin has a ring-and-ball softening point of from about 50 to about 150° C.

19. The adhesive article of claim 15, wherein the hot melt pressure-sensitive adhesive composition comprises less than about 0.01 wt % of the block copolymer.

20. The adhesive article of claim 15, wherein the adhesive composition has a clear visual determination, wherein the visual determination consists of providing a testing square consisting of a piece of white 20 pound weight paper having a brightness of 90%, the testing square having a printed portion comprising the capital letters “O” and “Q” printed with a laser printer to be visually distinguishable at 1 space apart from each other thereon in black text using 10-point Helvetica font;
depositing a sample of the composition at a temperature above the melting point of the composition onto the testing square using a flat applicator to cover the printed portion of the testing square with a film of the composition having a thickness of 1 mm, followed by allowing the composition to cool to a temperature of 25° C. to produce a prepared test sample; and
visually determining the clarity of the prepared test sample wherein the prepared test sample has a clear visual determination when an observer having essentially 20:20 vision is able to visually distinguish the letter “O” from the letter “Q” in the printed portion of the testing square at a distance of about 30 cm from the prepared test sample at an illumination of 1000 lux.

21. The adhesive article of claim 15, wherein the adhesive article is an adhesive tape having an initial 180° peel strength of the tape on glass of from 0.1 to about 10 N/25 mm at a coating weight of 20 g/m².

22. The adhesive article of claim 15, wherein the adhesive article is an adhesive tape having an initial 180° peel strength of the tape on polyethylene film of from 0.1 to about 10 N/25 mm at a coating weight of 20 g/m².
